(19) United States
(12) Patent Application Publication
(10) Pub. No.: US 2020/0209920 A1
(43) Pub. Date: Jul. 2, 2020

(54) LATCHING INTERFACE

(71) Applicant: Hewlett-Packard Development Company, L.P., Spring, TX (US)

(72) Inventors: Peter W Austin, Houston, TX (US); Javier Enrique Guerrero, Houston, TX (US); Michael J Pescetto, Houston, TX (US)

(73) Assignee: Hewlett-Packard Development Company, L.P., Spring, TX (US)

(21) Appl. No.: 16/606,925

(22) PCT Filed: Jun. 27, 2017
(86) PCT No.: PCT/US2017/039484

§ 371 Date: Oct. 21, 2019

(51) Int. Cl. G06F 1/16; F16M 11/04; G07G 1/00; G06Q 20/20

(52) U.S. Cl. CPC G06F 1/1632; G06Q 20/20; G07G 1/0018; F16M 11/041

(57) ABSTRACT

Example implementations relate to a latching system. An example latching system can include a compute unit include a first latching interface and a mounting device including a second latching interface to receive the first latching interface. The compute unit can be resiliently connected electrically and mechanically to the mounting device via the first and the second latching interfaces.

### BACKGROUND

A point of sale (POS) is a time and a place a retail transaction is completed. A retail point of sale (RPOS) device is the device used to complete the transaction. An all-in-one (AiO) RPOS device can include a computing device built in to a monitor chassis.

### BRIEF DESCRIPTION OF THE DRAWINGS

FIG. 1 illustrates a diagram of a latching system including a first latching interface and a second latching interface;

FIG. 2 illustrates another diagram of a latching system including a first latching interface and a second latching interface;

FIG. 3 illustrates a diagram of a mounting device including a latching interface;

FIG. 4 illustrates a diagram of compute unit including a latching interface;

FIG. 5 illustrates a diagram of cross-section of a latching interface;

FIG. 6 illustrates a diagram of a portion of a latching interface;

FIG. 7 illustrates a diagram of a latching system;

FIG. 8 illustrates another diagram of a latching system;

FIG. 9 illustrates an exploded view diagram of a latching system;

FIG. 10 illustrates a diagram of a latched latching system;

FIG. 11 illustrates another diagram of a latched latching system;

FIG. 12 illustrates a diagram of a cross-section of a wall-mount latching system;

FIG. 13 illustrates a diagram of a rear view of a wall-mount latching system;

FIG. 14 illustrates a diagram of a bottom view of a wall-mount latching system; and

FIG. 15 illustrates a diagram of a rear view of a wall-mount latching system including an opening for a cable.

### DETAILED DESCRIPTION

AiO RPOS devices can reduce space needed for components of RPOS systems, such as a computing device, a monitor, a mouse, and/or a keyboard, among other components. A compute unit of an AiO RPOS device can be a display monitor that may not have a battery, such that it does not house its own power source. For instance, the compute unit can be powered by direct current power supplied by a power cable and can be connected to a network, peripheral devices, and/or or devices via other cable connections. The compute unit can be a touch screen display monitor, such that a user can interact with the compute unit without a mouse or other control pad. Tasks including customer check-out and product look-up, among others, can be performed using the compute unit.

Some compute units can be physically connected to a counter, wall, etc. via a mounting device such as a stand or pole. For instance, a compute unit can be connected to the mounting device via bolts or screws within or on top of the mounting device. That mounting device can be physically connected to a counter top in a retail setting, for example. In order to detach the compute unit from the mounting device, a portion of the mounting device or compute unit is removed, and tools are used to do so. Cable power and data connections are attached and detached separately. This can result in a multi-step process to connect and disconnect a compute unit from a mounting device. In some approaches, a time-consuming removal process may result in AiO RPOS devices, particularly the compute device portion, being left unsecured or in the open leaving it susceptible to theft.

Examples of the present disclosure can include a latching system that allows for both electrical and mechanical connections of a compute unit of an AiO RPOS device to a mounting device. The electrical and mechanical connections can be resilient, such that the connections are releasable, removable, detachable, etc. For instance, the connections may not be permanent connections.

In some examples, the latching system can include a first latching interface located on a compute unit, and a second latching interface located on a mounting device. The two latching interfaces can latch together, and alignment assists can be used for ease in the latching (e.g., an alignment assist socket engaging with an alignment assist disc).

The latching system can allow for tool-less latching of the compute unit from the mounting device and can reduce cable clutter, in some examples, by routing cables through the mounting device, for example. In some examples of the present disclosure, latching of the compute unit to the mounting device can occur in a single tool-less act of pressing the compute unit to the mounting device at latching interfaces located on the compute unit and the mounting device. Removal can be performed using a screwdriver or rod, for instance, and can allow for unlatching of the compute unit from the mounting device for secure storage, in some examples. The latching system can allow for a resilient connection between the compute unit and the mounting device. For instance, when a compute unit is not in use (e.g., store closing time, lunch time, etc.), the compute unit can be unlatched and locked in a secure cabinet while leaving the mounting device in place. This can reduce an amount of secure storage space required, as the compute unit is smaller than the compute-unit-plus-mounting-device combination.

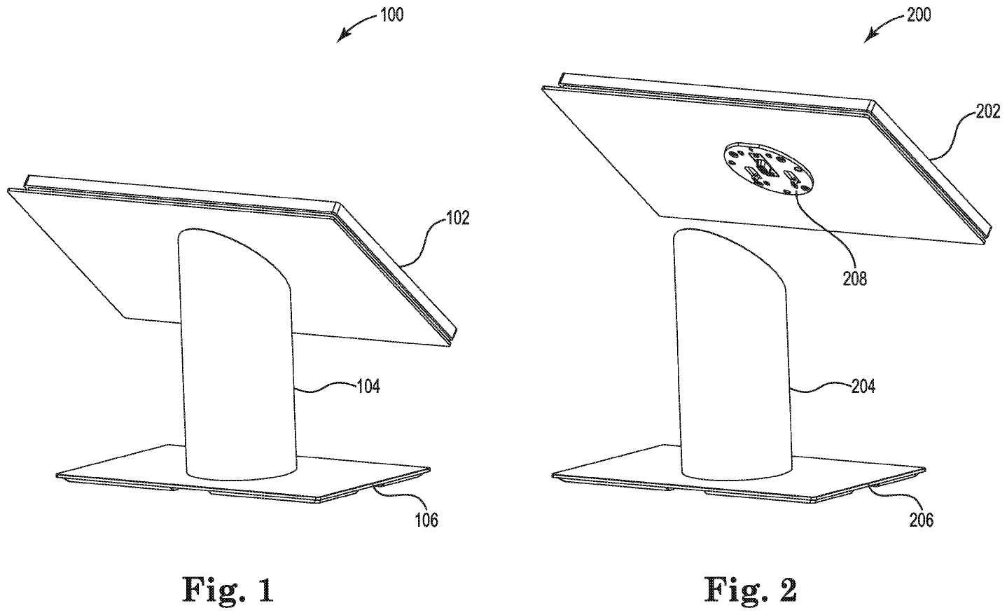

FIG. 1 illustrates a diagram of a latching system 100 including a first latching interface and a second latching interface. FIG. 1 illustrates latching system 100 in a latched position. Latching system 100 can include a mounting device 104 having a second latching interface connected to a first latching interface housed on a compute unit 102. Compute unit 102, in some examples, can be an AiO RPOS compute unit. In some examples, compute unit 102 does not house a battery. In some examples, compute unit 102 does house a battery and can perform as a tablet, for instance. Mounting device 104, in some examples, can be a stand for physically connecting to a counter or other desired location. For instance, the stand can be connected to a counter directly, or mounting device 104 can be connected to plate 106 which can connect mounting device 104 to a counter or other desired location.

Latching system 100 can include an AiO RPOS device. The AiO RPOS device can include compute unit 102, which can be communicatively connected to other components (not illustrated) of the AiO RPOS device. As used herein, communicatively connected can include being connected via various wired and/or wireless connections such that data can be transferred in various directions between the compute unit and other components. For instance, compute unit 102 can couple electronically and mechanically to mounting device 104, and connections can be housed within mounting device 104 that connect compute unit 102 to other components of the AiO RPOS device.

FIG. 2 illustrates another diagram of a latching system 200 including a first latching interface and a second latching interface. FIG. 2 illustrates latching system 200 in an unlatched position. For instance, compute unit 202, which houses first latching interface 208, is unlatched from mounting device 204 and plate 206. No cables are visible in FIG. 2, as cables can be housed within mounting device 204, reducing cable clutter.

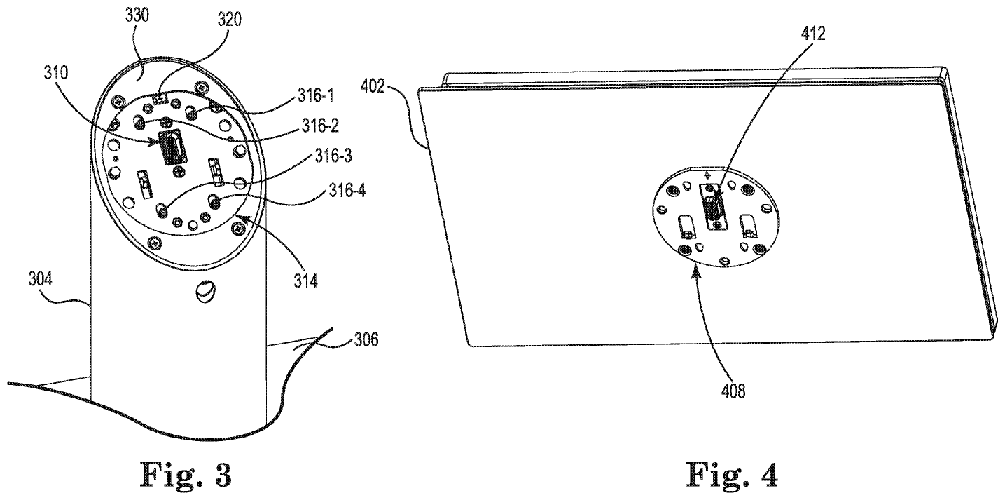

FIG. 3 illustrates a diagram of a mounting device 304 including a second latching interface 330. FIG. 4 illustrates a diagram of compute unit including a first latching interface 408. For ease of description, FIGS. 3 and 4 are described together.

Mounting device 304 can be connected to plate 306, which can connect mounting device 304 to a counter or other surface where it is desired to house an AiO RPOS device. For instance, plate 306 may be used to connect mounting device 304 to a check-out lane counter in a retail store. Mounting device 304 can house a second latching interface 330 to connect to a first latching interface housed on an associated compute unit 402. The second latching interface can include a plurality of components for mechanically and electrically connecting the mounting device 304 to the compute unit 402. The connections can be resilient. For instance, mechanical connections can include latching using hooks and latch pins, as will be discussed further herein. Electrical connections can include connections via a female electrical connector 310 and a male electrical connector 412. As used herein, an electrical connector includes an electro-mechanical device used to join electrical terminations and create an electrical circuit. Examples include plug and socket connectors and component and device connectors, among others. The electrical connectors can include universal serial bus (USB) connectors, power connectors, direct current (DC) connectors, and/or hybrid connectors, among others.

The second latching interface can include an alignment assist socket 314. The alignment assist socket 314 can accommodate a shape of first latching interface 408, which can be referred to as an alignment assist disc. The disc can help guide latching of the compute unit 402 with the mounting device 304 by acting as a guide. For instance, as illustrated in FIGS. 3 and 4, alignment assist socket 314 can be a round shape that is approximately the same round shape as the first latching interface 408, or alignment assist disc. Because alignment assist socket 314 is an indentation, it can accept the alignment assist disc, which is protruded. Put another way, alignment assist socket 314 can accept the first latching interface 408 via the alignment assist disc. While a round shape is illustrated in FIGS. 3 and 4, other shapes may be used for alignment assist socket 314 and alignment assist disc 408.

The second latching interface can include a female electrical connector 310 that can be communicatively connected to male electrical connector 412 on the first latching interface 408 when compute unit 402 is latched to mounting device 304 via the first and the second latching interfaces. For instance, power and data can be fed via the communicatively coupled male electrical connector 412 and female electrical connector 310 and cables running through the center of mounting device 304. In some examples, this can reduce cable clutter at an RPOS device and/or system, such that cable is no longer visible protruding from the AiO RPOS device compute unit 402. For example, plate 306 can be connected to a table, and cables can exit the mounting device 304 under the table, hiding the cables from view.

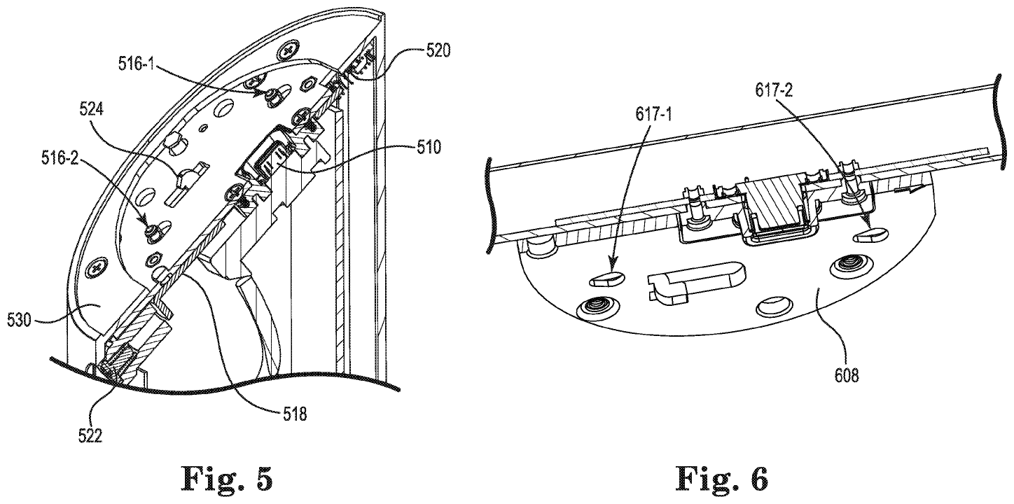

FIG. 5 illustrates a diagram of cross-section of a second latching interface 530. In the example illustrated, the cross-section runs through the center of a mounting device on which the second latching interface 530 is housed, through the center of the female electrical connector 510. In some examples, the second latching interface 530 can be housed on a mounting device as illustrated in FIG. 3 (e.g., latching interface 330).

The second latching interface 530 can include latch pins 516-1 and 516-2. Latch pins 516 can be mounted on a spring return latch plate 518 that can be spring-loaded via spring 520. Latch pins 516 in some examples can be grooved, such that a top end of each latch pin can be beveled for engagement and securing with keyholes, as will be discussed further herein. While two latch pins 516 are illustrated in FIG. 5 (making four total pins on the first latching interface), more or fewer latch pins 516 may be used.

In some examples, the second latching interface 530 can include a screw 522. Screw 522 can be a tamper-resistance screw and can be a security feature. For instance, screw 522 can be a tamper-resistant torque screw that can be removed when a particular screwdriver, such as a tamper-resistance screwdriver, is used. In order to remove a compute unit (e.g., unlatch the first and the second latching interfaces) from a mounting device, the particular screwdriver can be used to remove screw 522, an object (e.g., screwdriver, rod, etc.) can be used to press spring return latch plate to compress spring 520, and the compute unit can be removed. The compute unit can stay latched without screw 522; however, the use of screw 522 can prevent unauthorized users from removing the compute unit because the particular screwdriver may be needed for removal of the screw 522. Put another way, the second latching interface 530 can include an opening to receive screw 522 to prevent access to the spring-return sliding latch plate, which would allow for removal of the compute unit.

The second latching interface 530 can include female electrical connector 510, which can receive a male electrical connector of a first latching interface housed on the compute unit. When connected, data and power can be fed to and from the compute unit to an input/output (I/O) hub that can provide I/O functions to the compute unit and other devices connected to the I/O hub. In some examples, connections to and/or from the I/O can be universal serial bus (USB) type-C connections and/or other connections that can facilitate hot-mate docking actions including replacing or adding components without stopping or shutting down an associated AiO RPOS device.

FIG. 6 illustrates a diagram of a portion of a first latching interface 608. First latching interface 608 can be housed on a compute unit and can include keyholes 617-1 and 617-2, which can be openings to receive latch pins located on the second latching interface. For instance, keyholes 617 can receive latch pins 516 shown in FIG. 5. The latch pin-keyhole connection can be part of a resilient mechanical connection between a compute device and a mounting device. Keyholes 617 can align with latch pins, such that when the first latching interface is latched with the second latching interface, the latch pins can line up with and fit in keyholes 617. The amount of keyholes 617 can be the same as the amount of latch pins on an associated latching interface; however, in some instances, more keyholes 617 than latch pins may be present. In some examples, latch pins can engage with keyholes 617, and in response to a spring return latch plate (such as spring return latch plate 518 in FIG. 5) returning to an un-actuated position, the first and the second latching interfaces can be latched together, as will be discussed further herein.

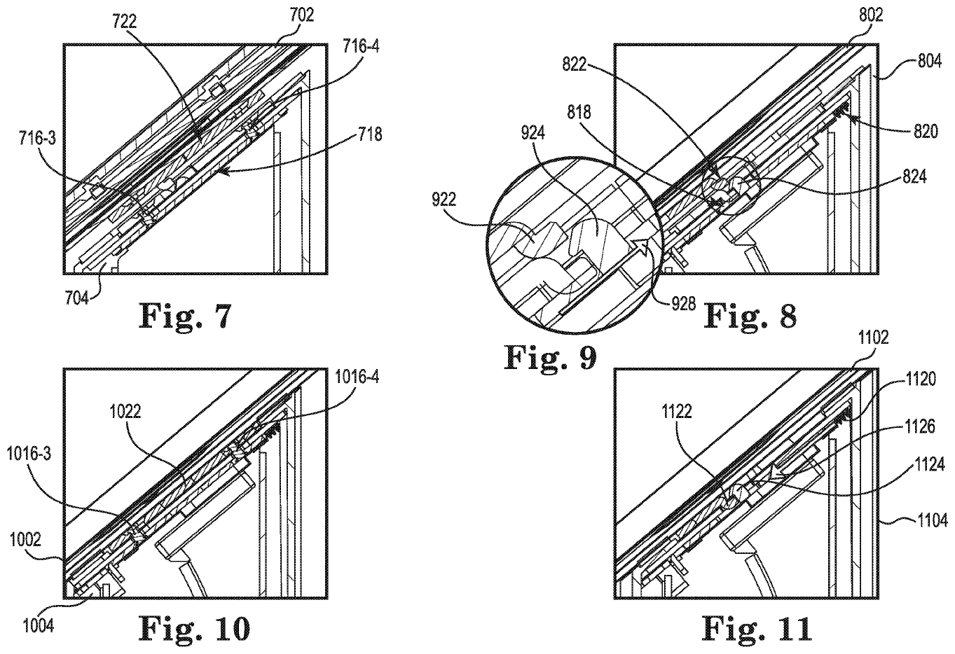

FIG. 7 illustrates a diagram of a latching system. For instance, FIG. 7 illustrates a portion of the latching process that includes the use of latch pins 716-3 and 716-4 housed on spring return latch plate 718 to strengthen a latch connection between compute unit 702 and mounting device 704. FIG. 8 illustrates another diagram of a latching system. For example, FIG. 8 illustrates a portion of the latching process including engagement of a hook with a lip housed on fixed latch plate 822 and a hook 824 housed on spring return latch plate 818. In some examples, the portions of the latching processes illustrated in FIGS. 7 and 8 can occur simultaneously. FIG. 9 illustrates an exploded view diagram of a latching system. For instance, FIG. 9 is an exploded view of the circle shown in FIG. 8. For ease of description, FIGS. 7, 8, and 9 are described together. FIGS. 7, 8, and 9 illustrate a resilient mechanical connection of a first latching interface and a second latching interface during a latching process. For instance, the latching process can include pressing compute unit 702, 802 to a mounting device 704, 804 to electrically and mechanically connect the two via the first and the second latching interfaces. The electrical and mechanical connections can be made tool-lessly.

The compute unit 702, 802 can have a fixed latch plate 722, 822, 922 that includes a hook having a lip to engage with a hook 824, 924 having an angled edge when the compute unit 702, 802 is pressed against the mounting device for latching. For example, the latching system of FIGS. 7, 8, and 9 can allow for a resilient connection between the compute unit and the mounting device via engagement of the fixed latch plate 722, 822, 922 and the spring return latch plate 718, 818. Though one hook 824, 924 is illustrated in each of FIGS. 8 and 9, more than one hook may be housed on fixed latch plate 722, 822, 922.

In some examples, when the compute unit 702, 802 is pressed against the mounting device 704, 804, hook 824, 924 at an end of spring return latch plate 718, 818 can be contacted by the hook at the end of fixed latch plate 722, 822, 922 causing the hook 824, 924 to be moved in the direction of arrow 928, and forcing the lip of the hook of fixed latch plate 722, 822, 922 to engage with hook 824, 924. In response to the engagement, spring return latch plate 718, 818 can reverse enough while the compute unit 702, 802 is pressed for the latch pins to be inserted into a larger end of the keyholes (e.g., latch pins 516 and keyholes 617 as described in FIGS. 5 and 6). In response to the hooks being engaged with one another and pressure being released from the compute unit 702, 802, the spring 820 can return to a relaxed position, resulting in the latch pins sliding to a smaller end of the keyholes. In some examples, latch pins 716-3 and 716-4 can be located on spring return latch plate 718, 818 to strengthen the latch connection between compute unit 702 and mounting device 704, as will be discussed further herein with respect to FIG. 10. While two latch pins 716 are illustrated in FIG. 7, more or fewer may be present.

FIG. 10 illustrates a diagram of a latched latching system. The latching system can mechanically and resiliently connect compute unit 1002 to mounting device 1004, and can include latch pins 1016-3 and 1016-4 that engage with fixed latch plate 1022 and provide latching points in addition to two other latch pin/keyhole attachment points and two hook lip-to-hook 824, 924 engagements. In such an example, compute unit 1002 can have a snug fit to mounting device 1004, such that movement of compute unit 1002 while latched to mounting device 1004 is below a desired movement threshold. While six total latching points are described herein, more or fewer latching points in different combinations may be used.

FIG. 11 illustrates another diagram of a latched latching system. The lip of the hook of the fixed latch plate 1122 can be engaged with hook 1124 of the spring return latch plate, such that when pressure is applied and subsequently released from the compute unit 1102, the spring return latch plate and the spring 1120 can return to a relaxed position, for instance following the direction of arrow 1126, resulting in latching of the compute unit 1102 to the mounting device 1104 via the first and the second latching interface. The latched connection of FIG. 11 can be resilient, such that when a rod, screwdriver, or other object is pressed on a spring return latch plate, the compute unit 1102 can be removed from the mounting device 1104.

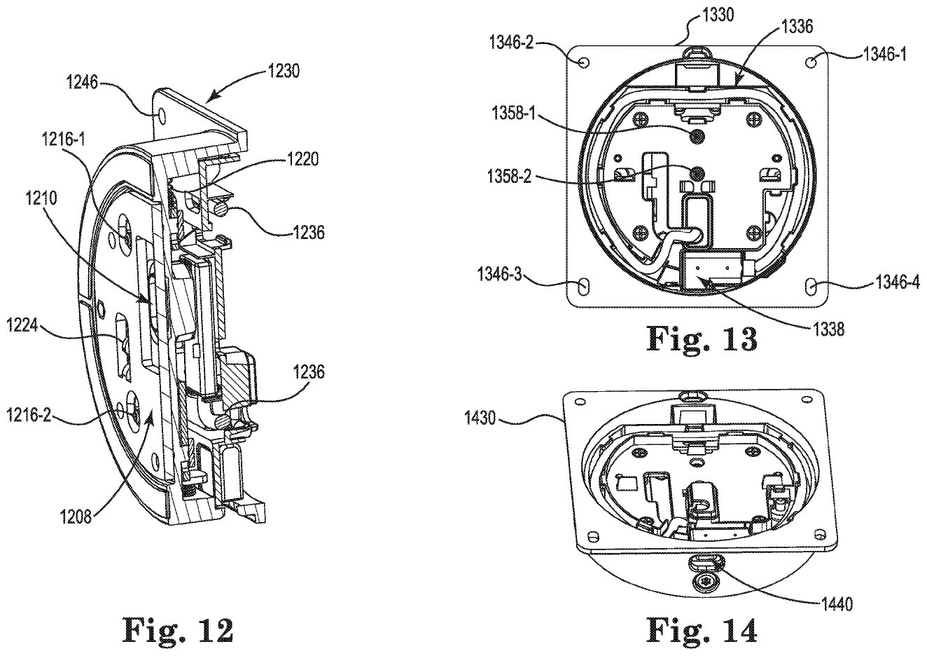

FIG. 12 illustrates a diagram of a cross-section of a wall-mount latching system. While described as a wall-mount latching system, examples are not limited to mounting on a wall. For instance, examples can include mounting to a pole, table, or other desired surface. The wall-mount latching system, in some examples, can include the same components of the mounting device latching system described above, but can be mounted to a wall, pole, table, or other desired surface (e.g., vertical surface). For instance, the wall-mount latching system can include a same or similar second latching interface 1208 as illustrated in FIGS. 2 and 4 coupled to a wall-mount latching interface 1230. For instance, the latching system of FIG. 12 can include a female electrical connector 1210, latch pins 1216-1 and 1216-2, spring 1220, and hook 1224. While two latch pins are illustrated in FIG. 12, more latch pins may be present (e.g., four total latch pins). In the diagram illustrated in FIG. 12, the second latching interface is coupled to the wall-mount latching interface 1230. Though not illustrated in FIG. 12, the second interface latching interface can be connected to a compute unit in a same or similar manner as illustrated in FIGS. 2 and 4. Wall-mount latching system can include resilient electrical connections via female connector 1210 and a mating male connector and resilient mechanical connections same or similar to those described with respect to FIGS. 7-11. The electrical and mechanical connections can be made tool-lessly.

In some examples, wall-mount latching interface 1230 can be mountable to a wall, pole, etc. For instance, a retailer may desire to mount a compute unit to a wall, a freestanding pole, a pole bolted to a table, etc. for display or easy access. The wall-mount latching interface can meet Video Electronics Standards Associate (VESA) Mounting Interface Standards (MIS) for mounting flat panel displays to poles or wall mounts, for example. For instance, wall-mount latching interface 1230 can include holes 1246 per VESA MIS such that it can be mounted to a VESA interface, including a wall, pole, or other mounting device that can accept VESA MIS mounts.

In the example illustrated in FIG. 12, a cable 1236 connecting the compute unit to power and/or data received at the female electrical connector 1210 can be fed through the wall-mount latching interface 1230 and routed around the rear of it in a channel, as will be discussed further herein.

FIG. 13 illustrates a diagram of a rear view of a wall-mount latching system. For instance, the wall-mount latching system can include wall-mount latching interface 1330 that can latch to a latching interface housed on a compute unit. Wall-mount latching interface 1330 can include holes 1346-1, 1346-2, 1346-3, 1346-4 to attach wall-mount latching interface 1330 to a wall, pole, flat display mounting interface mounting device, VESA mounting device, or other mounting device. Connectors 1358-1 and 1358-2 can include screws holding the female electrical connection 1312 to latching interface 1330, and cable 1336 coming from the female-to-male electrical connection can be routed through a channel 1354 around a perimeter of wall-mount latching interface 1330 to a protective pocket 1338, which can protect a connection point (not illustrated). External connections (e.g., USB-C connections, etc.) can be made at this connection point to transfer data and/or power to/from the compute unit.

FIG. 14 illustrates a diagram of a bottom view of a wall-mount latching system. For instance, the wall-mount latching system can include wall-mount latching interface 1430 that can latch to a latching interface housed on a compute unit Wall-mount latching interface 1430 can include connection point 1440 to receive external connections for transferring data and/or power to/from the compute unit. For instance, connection point 1440 can receive a power supply, data cable, or other external connection that can be connected to a hub (e.g., I/O hub elsewhere). The compute unit can be powered via connection point 1440, for example.

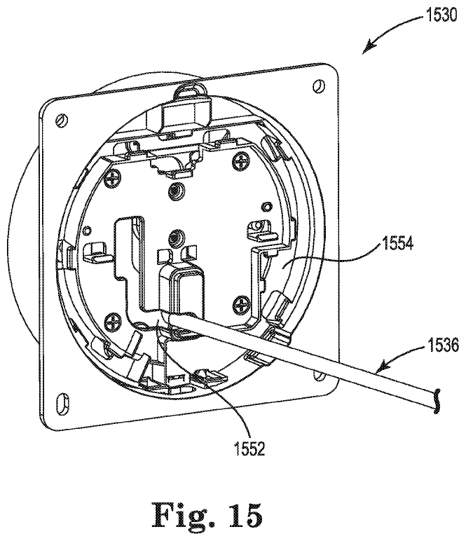

FIG. 15 illustrates a diagram of a schematic rear view of a wall-mount latching system including an opening 1552 for a cable. Wall-mount latching interface 1530 can include an opening 1552 to allow cable 1536 to pass into a wall, pole, etc. For instance, cable 1536 can be removed from channel 1554 and routed directly into the wall, pole, etc. or to a connection in the wall, pole etc. In some examples, this can reduce cable clutter by moving cable into the wall or down a pole, hiding the cable from view.

In the foregoing detailed description of the present disclosure, reference is made to the accompanying drawings that form a part hereof, and in which is shown by way of illustration how examples of the disclosure can be practiced. These examples are described in sufficient detail to enable those of ordinary skill in the art to practice the examples of this disclosure, and it is to be understood that other examples can be utilized and that process, electrical, and/or structural changes can be made without departing from the scope of the present disclosure.

The figures herein follow a numbering convention in which the first digit corresponds to the drawing figure number and the remaining digits identify an element or component in the drawing. For example, “102” may reference element “06” in FIG. 1, and a similar element may be referenced as 102 in FIG. 2. Multiple analogous elements within one figure may be referenced with a reference numeral followed by a hyphen and another numeral or a letter. For example, 516-1 may reference element 16-1 in FIGS. 5 and 516-2 may reference element 16-2, which can be analogous to element 16-1. Such analogous elements may be generally referenced without the hyphen and extra numeral or letter. For example, elements 516-1 and 516-2 may be generally referenced as 516.

Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

What is claimed:

1. A system, comprising:
an all-in-one retail point of sale compute unit including a first latching interface, the first latching interface including a fixed latch plate; and
a mounting device including a second latching interface to receive the first latching interface, the second latching interface including a spring return latch plate,
wherein the compute unit is resiliently connected electrically and mechanically to the mounting device via engagement of the fixed latch plate of the first latching interface with the spring return latch plate of the second latching interfaces.

2. The system of claim 1, wherein the mounting device comprises a stand for the compute unit.

3. The system of claim 1, wherein the mounting device comprises a flat display mounting interface mounting device.

4. The system of claim 1, wherein the mounting device comprises a VESA mounting device.

5. An apparatus, comprising:
a first latching interface housed on a compute unit and resiliently connected mechanically and electrically to a second latching interface, the first latching interface having an opening to receive a latch pin; and
the second latching interface housed on a mounting device and comprising a spring-return sliding latch plate housing the latch pin received at the first latching interface.

6. The apparatus of claim 5, wherein the second latching interface includes a socket to receive the first latching interface, wherein the socket is a same shape as the first latching interface.

7. The apparatus of claim 5, wherein the first latching interface includes a first electrical connector to connect to a second electrical connector on the second latching interface.

8. The apparatus of claim 5, wherein the latch pin is a grooved latch pin.

9. The apparatus of claim 5, wherein the second latching interface comprises an opening to receive a screw to prevent access to the spring-return sliding latch plate.

10. A system comprising:
a compute unit resiliently connected to a mounting device mechanically and electrically via a latching system; and
the latching system, comprising:
a first latching interface on the compute unit comprising:
a plurality of holes for receiving a plurality of latch pins of a second latching interface on the mounting device; and
a fixed latch plate; and
the second latching interface to receive the first latching interface and comprising:
the plurality of latch pins;
a spring return latch plate to engage with the fixed latch plate; and
a connection point to receive external cables.

11. The system of claim 10, wherein:
the mounting device is a flat display mounting interface wall mounting device; and
wherein the second latching interface further comprises an opening to route cable from the compute unit, through the second latching interface, and into a wall.

12. The system of claim 10, wherein the second latching interface further comprises a cable channel to route cable from the compute unit through the second latching interface.

13. The system of claim 10, the second latching interface to receive the first latching interface tool-lessly.

14. The system of claim 10, wherein the spring return latch plate comprises an angled edge to engage with a lip of the fixed latch plate.

15. The apparatus of claim 10, wherein the compute unit is an all-in-one retail point-of-sale compute unit.
